(19) United States
(12) Patent Application Publication
(10) Pub. No.: US 2013/0275683 A1
(43) Pub. Date: Oct. 17, 2013

(54) Programmably Partitioning Caches

(71) Applicant: Nicolas Kacevas, Folsom, CA (US)

(72) Inventor: Nicolas Kacevas, Folsom, CA (US)

(73) Assignee: Intel Corporation, Santa Clara, CA (US)

(21) Appl. No.: 13/995,197

(22) PCT Filed: Aug. 29, 2011
(86) PCT No.: PCT/US11/49584

§ 371 Date: Jun. 18, 2013

(51) Int. Cl. G06F 12/10

(52) U.S. Cl. CPC G06F 12/1045
USPC 711/128; 711/118

(57) ABSTRACT

Agents may be assigned to discrete portions of a cache. In some cases, more than one agent may be assigned to the same cache portion. The size of the portion, the assignment of agents to the portion and the number of agents may be programmed dynamically in some embodiments.

### BACKGROUND

This relates generally to the use of storage in electronic devices and, particularly, to the use of storage in connection with processors.

A processor may use a cache to store frequently reused material. By storing frequently reused information in the cache, the information may be accessed more quickly.

In modern processors, translation lookaside buffers (TLBs) store address translations from a virtual address to a physical address. These address translations are generated by the operating system and stored in memory within page table data structures, which are used to populate the translation lookaside buffer.

### BRIEF DESCRIPTION OF THE DRAWINGS

FIG. 1 is a system depiction for one embodiment of the present invention;

FIG. 2 is a schematic depiction of cache partitioning in accordance with one embodiment of the present invention;

FIG. 3 is a schematic depiction of a cache partition assignment and replacement algorithm in accordance with one embodiment of the present invention; and

FIG. 4 is a flow chart for one embodiment of the present invention.

### DETAILED DESCRIPTION

In accordance with some embodiments, a cache may be broken up into addressable partitions that may be programmably configured. The cache size may be configured programmably, as may be the assignment of agents to particular partitions within the cache. In addition, it may be programmably determined whether or not two or more agents may be assigned to use the same cache partition at any time period.

In this way, more effective utilization of available cache space may be achieved in some embodiments. This may result in more efficient accessing of information from the cache, in some cases, which may improve access time and may improve the amount of information that can be stored within a cache.

Programming of the partitioning of the cache may be done statically, in that it is set from the beginning and is not changed. Partitioning may also be done dynamically, programmably adjusting to changing conditions during operation of an associated processor or controller.

While the following example refers to a translation lookaside buffer, the present invention is applicable to a wide variety of caches used by processors. In any case where multiple clients or agents request access to a cache, partitioning the cache in a programmable way may prevent clients from thrashing each other to access the cache.

As used herein, an “agent” may be code or hardware that stores or retrieves code or data in a cache.

In some embodiments, the cache may be fully associative. However, in other embodiments, the cache may be any cache with a high level of associativity. For example, caches with associativity higher than four-way associativity may benefit more from some aspects of the present invention.

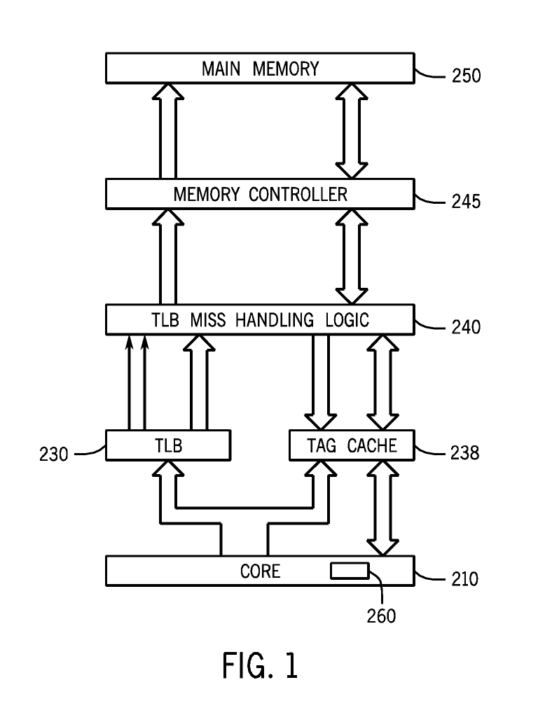

The cache 230, shown in FIG. 1, is illustrated as a translation lookaside buffer, but the present invention is in no way limited to translation lookaside buffers and it is applicable to caches in general.

The system shown in FIG. 1 may be a desktop or mobile device. For example, the system may be a laptop, a tablet, a mobile Internet device (MID), or a smart phone, to mention some examples.

The core 210 may be any processor, controller, or even a direct memory access (DMA) controller core. The core 210 may include a storage 260 that may store software for controlling the programming of partitions within the translation lookaside buffer 230. In other embodiments, the programming may be stored externally of the core. The core may also communicate with a tag cache 238 in an embodiment that uses stored kernel accessible bits that include state information or metadata for each page of memory. Connected to the translation lookaside buffer and tag cache is a translation lookaside buffer miss handling logic 240, in turn, coupled to a memory controller 245 and main memory 250, such as a system memory.

The core may request information in a particular page of main memory 250. Accordingly, core 210 may provide an address to both the translation lookaside buffer 230 and tag cache 238. If the corresponding physical to virtual translation is not present in the translation lookaside buffer 230, a translation lookaside buffer miss may be indicated and provided to the miss handling logic 240. The logic 240, in turn, may provide the requested address to the memory controller 245 to enable loading of a page table entry into the translation lookaside buffer 230. A similar methodology may be used if a requested address does not hit a tag cache entry in the tag cache, as a request may be made through the miss handling logic 240 and memory controller 245 to obtain tag information from its dedicated storage in main memory 250 and to provide it for storage in the tag cache 238.

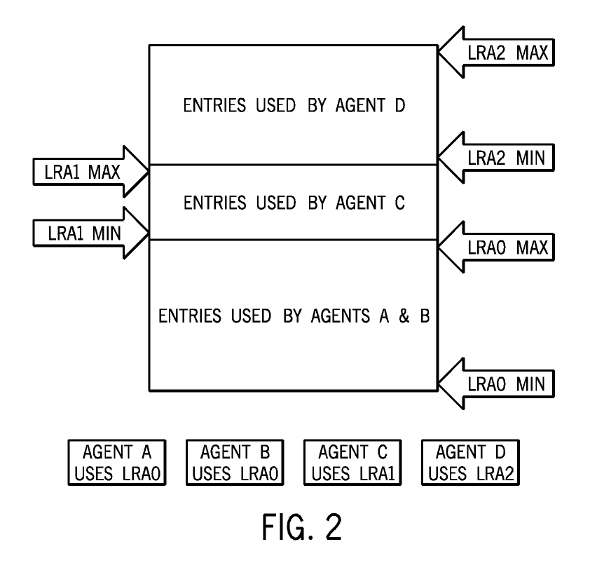

The cache 238 may be partitioned, as shown in FIG. 2. In this example, there are four agents, agents A-D. Any number of agents may be accommodated in other embodiments. The lowermost cache (i.e., the one with lower numbered addresses) is assigned to agents A and B, the middle cache is assigned to agent C, and the top cache is assigned to agent D, in this example. The partitions are defined, in this example, using minimum and maximum addresses called LRA0, LRA1, LRA2, minimum and maximum. The bottom and top cache lines of a partition may be identified by their addresses for each partition in one embodiment.

While an example is given wherein the cache is divided into partitions or portions based on cache line addresses, caches may also be partitioned based on other granularities of memory, including blocks, sets of blocks, and conventional partitions.

Thus, the size of each partition may be defined by its minimum and maximum addresses in the example illustrated in FIG. 2. Likewise, the assignments of agents to partitions may be determined programmably. Finally, whether or not to use overlapping (where more than one agent is assigned to the same partition) may be determined programmably.

For example, with respect to overlapping, it may be determined whether two or more agents are likely to use a partition at the same time. If so, it may be more efficient to assign the agents to different partitions. However, if the agents are likely to use the partition at different times, the usage of the partition is more effectively allocated if the same agents are assigned to the same partition. Other rationales for assigning overlapping agents to a partition, or not, may also be used.

In addition, different agents may be provided with partitions of different programmable size. A wide variety of considerations may go into programming partition size, including known relationships with respect to how much cache space is used by a particular agent or type of agent. Moreover, the size of the partition may be adjusted dynamically during the course of partition usage. For example, based on rate of cache line storage, more lines may be allocated. Likewise, agents may be reassigned to partitions dynamically and overlapping may be applied or undone dynamically, based on various conditions that may exist during processing.

The partitions may also overlap in other ways. For example, an agent A may use half of the available entries of a partition, agent B may use the other half, and agent C may use all of the entries. In this case, the partition is split between two agents, each of which uses a portion of the partition, while another agent overlaps with each of those agents. To implement such an arrangement, LRA A is mapped to the lower half, LRA B is mapped to the upper half, and LRA C is mapped to the whole partition, overlapping with the regions A and B. This type of mapping may be useful if the agents A and B are active at the same time, while agent C is active at a different time.

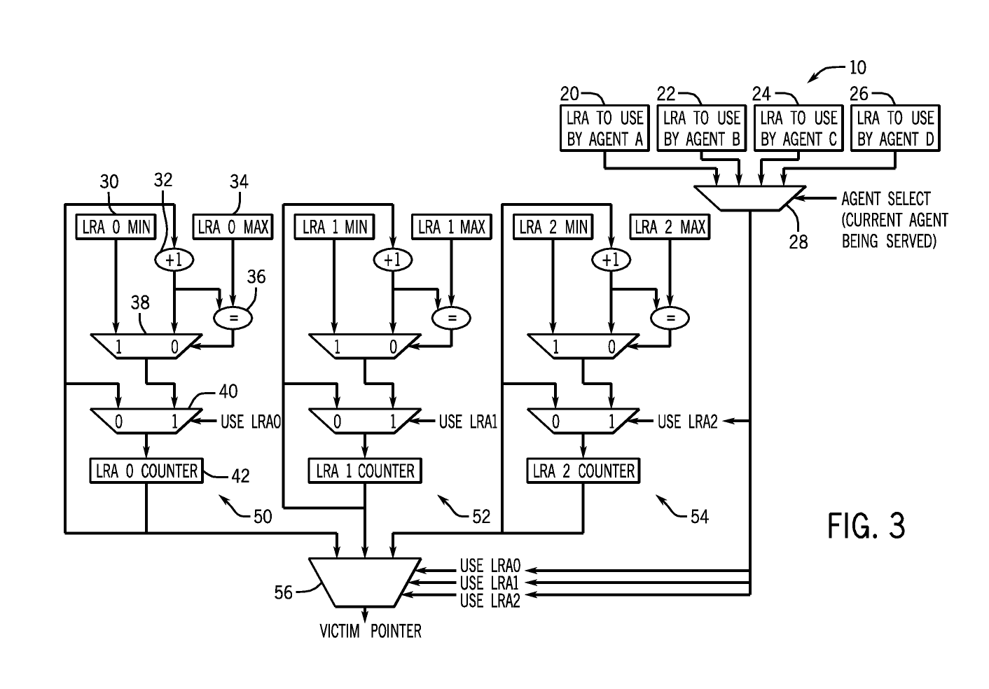

Referring to FIG. 3, in accordance with some embodiments, an algorithm for assigning agents to cache partitions and a cache replacement policy is described. In some embodiments, a least recently allocated (LRA) cache replacement policy may be used.

In the upper right hand corner (at 10), the agents are programmably assigned to cache partitions. This may be done by assigning minimum and maximum addresses labeled LRA, followed by a number, and a minimum and a maximum address. Thus, a partition for use by agent A is assigned at block 20, a partition for use by agent B is assigned at block 22, a partition for use by agent C is assigned at block 24, and a partition for use by agent D is assigned at block 26.

An agent selection input (e.g., use LRA2) is provided to the multiplexer 28 to select a particular agent to be served. Then the block 50, 52, or 54, assigned to that particular agent, is activated when the agent is currently being served. Thus, if the agent D is assigned to LRA2, as illustrated in FIG. 2, then the line labeled “use LRA2” may be activated to activate the block 54, while the blocks 50 and 52 are inactive in one embodiment.

Each of the blocks 50, 52, and 54 may otherwise work the same way. Each block takes the minimum address and maximum address, such as LRA2 min and LRA2 max, in the case of block 54, and, on each use of the block, adds (block 32) one to a counter 38. Then a check at the multiplexer/counter 40 determines whether that LRA block has actually been selected. If so, the counter 40 is incremented. When the maximum address (i.e. the top address, for example) is reached (block 36), then the count rolls over and the least recently allocated address is overwritten in this embodiment. Embodiments may overwrite based on other schemes as well, including least used address.

Each of the registers 30 and 34 may be rewritten to change the size of the partition. In addition, it is an easy matter to change which block is assigned to which agent so that the agents can be programmably reassigned. Overlapping may be achieved simply by assigning the same partition with the same LRA min and max to two or more agents.

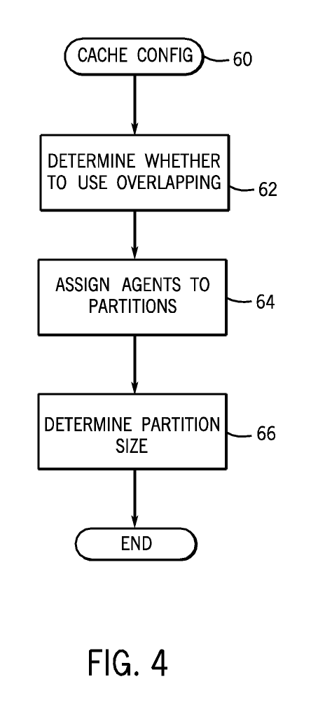

Referring to FIG. 4, in accordance with one embodiment, a cache configuration sequence 60 may be implemented in software, hardware, and/or firmware. In one embodiment, the cache configuration sequence 60 may be implemented in software as computer readable instructions stored in a non-transitory computer readable medium, such as an optical, magnetic, or semiconductor memory. As one example, the instructions may be stored in the storage 260 as part of a core 210. However, they may be stored instead independently of the core 210 and may be executed by the core 210 in some embodiments.

The core 210 may be any kind of processor, including a graphics processor, a central processing unit, or a microcontroller. The core 210 may be part of an integrated circuit which includes both graphics and central processing units integrated thereon or it may be part of any integrated circuit with multiple cores on the same integrated circuit. Similarly, the core 210 may be on its own integrated circuit without other cores.

Continuing with FIG. 4, first the core may determine whether to use overlapping, as indicated in block 62. Based on whether or not overlapping is used and based on characteristics of the agents that use the cache, agents may be assigned to partitions, as indicated in block 64. Then the partition size may be determined, as indicated in block 66, for example, by assigning minimum and maximum addresses. As mentioned previously, other partition assignment techniques may also be used, including assigning a given number of blocks or partitions to given agents.

In some embodiments, the order of the steps may be changed. Also, some of the steps may be dynamic and some may be static, in some embodiments. Some of the steps may be omitted in some embodiments. As still another example, different processors on the same integrated circuit may have different programmable configurations. In may also be possible for agents to share partitions associated with different processors, in some embodiments. In still other embodiments, a single partitioned cache may be used by more than one processor.

In some embodiments, registers may be provided for each agent to programmably store LRA min and LRA max, any overlapping and agent to cache partition assignments. The registers may also store partition granularity, for example, when partitions are made of a given number of regularly sized units, such as cache lines, blocks, or sets of blocks.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
programmably assigning agents to discrete portions of a cache.

2. The method of claim 1 including programmably assigning more than one agent to the same discrete cache portion.

3. The method of claim 1 including programmably setting the size of a cache portion.

4. The method of claim 1 including dynamically changing the assignments of one or more agents to a cache portion.

5. The method of claim 1 including assigning agents to discrete portions of a cache in the form of a translation lookaside buffer.

6. The method of claim 1 including using a cache having an associativity greater than four ways.

7. A non-transitory computer readable medium storing instructions to cause a core to:
assign more than one agent to a discrete part of a cache.

8. The medium of claim 7 further storing instructions to dynamically change the assignment of more than one agent to said discrete part of said cache.

9. The medium of claim 8 further storing instructions to programmably set the size of a cache part.

10. The medium of claim 8 further storing instructions to assign agents to discrete parts of a cache.

11. The medium of claim 10 further storing instructions to change the assignments of one or more agents to a cache part.

12. The medium of claim 8 further storing instructions to assigning agents to discrete parts of a cache in the form of a translation lookaside buffer.

13. The medium of claim 8 further storing instructions to use a cache having an associativity greater than four ways.

14. An apparatus comprising:
a processor core; and
a cache coupled to said core, said core to assign agents to discrete portions of a cache.

15. The apparatus of claim 14, said core to programmably assign more than one agent to the same discrete cache portion.

16. The apparatus of claim 14, said core to programmably set the size of a cache portion.

17. The apparatus of claim 14, said core to dynamically change the assignment of one or more agents to a cache portion.

18. The apparatus of claim 14 wherein said cache is a translation lookaside buffer.

19. The apparatus of claim 14, said cache having an associativity greater than four ways.

20. The apparatus of claim 14 wherein said core is a graphics core and said cache is a translation lookaside buffer.
